(19) United States
(12) Patent Application Publication
(10) Pub. No.: US 2007/0277750 A1
(43) Pub. Date: Dec. 6, 2007

(54) SHOCK ABSORBING LEASH EXTENSION USABLE WITH A VARIETY OF LEASHES AND A LEASH ASSEMBLY HAVING THE SAME

(76) Inventors: Daniel E. Valencia, Rockville, MD (US); Melissa D. Valencia, Rockville, MD (US)

Correspondence Address: Daniel Valencia, 10812 Antigua Terrace Apt. 103, Rockville, MD, 20852, US

(21) Appl. No.: 11/381,170

(22) Filed: May 2, 2006

(51) Int. Cl. A01K 27/00

(52) U.S. Cl. 119/798

(57) ABSTRACT

A shock absorbing leash extension and a leash assembly having the same. The leash extension includes an elastic portion having a first end and a second end, a first loop disposed at the first end of the elastic portion and being connectable to a first hook on a leash, and a second hook disposed at the second end of the elastic portion and being connectable to a second loop on a collar.

### BACKGROUND OF THE INVENTION

1. Field of the Invention

The present general inventive concept relates to a shock absorbing leash extension, and more particularly to, a shock absorbing leash extension usable with a variety of leashes.

2. Description of the Related Art

Typically, leashes have a maximum length that allows a pet freedom to roam to the maximum length of the leash. However, in some cases, when the pet gets to the maximum length, the pet's neck, spine, and back will get jerked due to the fact that the pet may not realize the maximum length. These types of jerks cause problems in pet's health, especially as the pet gets older. Additionally, pet owners may have to pay for expensive surgeries for their pets to remedy the effects of these jerks over the course of many years of walking their pet.

The pet's spine, neck, and back may also suffer injury over time as a result of the pet applying a force when the pet has reached the maximum length in an effort to obtain more slack from the leash. Since the pet is not as smart as a human, the pet does not realize that when the maximum length is reached, there is no more slack to obtain from the leash. In these cases, the pet will purposely apply a force using their neck to try to extend the leash further, when in fact the leash cannot extend any further. For example, this may occur when the pet is excited to investigate something the pet has seen close by (obviously not close enough). These situations may also cause pressure and stress on the neck, spine, and back of the pet and will cause health problems as the pet ages.

A few types of conventional elastic leashes, harnesses, and extensions have been proposed in an effort to remedy these problems. However, the conventional elastic leashes that have been proposed have typically been complicated in structure. Additionally, the conventional elastic leashes must be purchased in addition to any leashes that a pet owner already owns, and must be used instead of the leashes already owned by the pet owner.

### SUMMARY OF INVENTION

The present general inventive concept provides a shock absorbing leash extension usable with various types of leashes that has a simple structure and reduces abrupt shocks and jerks to a pet's neck, back, and spine that result when the pet gets to a maximum length of the leash.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a shock absorbing leash extension, including an elastic portion having a first end and a second end, a first loop disposed at the first end of the elastic portion and being connectable to a first hook on a leash, and a second hook disposed at the second end of the elastic portion and being connectable to a second loop on a collar.

The foregoing and/or other aspects of the present general inventive concept are achieved by providing a leash assembly, including a leash having a handle portion disposed at a first end thereof and a first hook disposed at a second end thereof, and a leash extension including an elastic portion having a first end and a second end, a first loop disposed at the first end of the elastic portion connected to the first hook on the leash, and a second hook disposed at the second end of the elastic portion.

The leash assembly may further include a collar having a second loop to be connected to the second hook of the leash extension.

The leash may be a retractable leash.

The elastic portion may include a first stitched portion at the first end of the elastic portion forming a first looped portion in the elastic portion through which the first loop is disposed, and a second stitched portion at the second end of the elastic portion forming a second looped portion in the elastic portion through which the second hook is disposed.

The second hook may include a looped portion to couple to the second end of the elastic portion, a coupling portion to couple to a collar, and a protrusion portion to control the coupling portion to open and close.

The elastic portion may include one of an elastic band, an elastic cord, a bungee cord, a rubber band, a rubber cord, and a spring. The elastic portion may be made of a STRETCHRITE material.

The leash extension may be less than one foot in length. The leash extension is less than six inches in length.

The foregoing and/or other aspects of the present general inventive concept are achieved by providing a leash extension, including a stretchable elastic portion, a first coupling portion connected at a first end of the elastic portion to removably couple to a leash, and a second coupling portion connected at a second end of the elastic portion to removably couple to a collar.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a leash assembly according to an embodiment of the present general inventive concept;

FIG. 2 illustrates a shock absorbing leash extension according to an embodiment of the present general inventive concept;

FIG. 3 Illustrates a shock absorbing leash extension according to another embodiment of the present general inventive concept;

FIG. 4 Illustrates a shock absorbing leash extension according to yet another embodiment of the present general inventive concept; and

FIG. 5 illustrates a shock absorbing leash extension according to yet another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

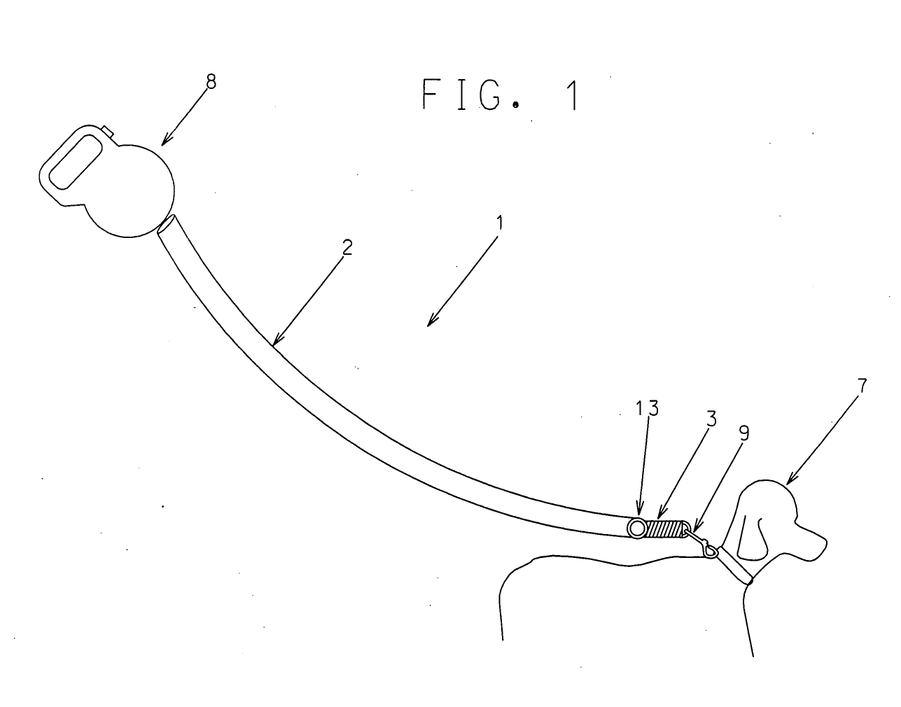

FIG. 1 illustrates a leash assembly 1 according to an embodiment of the present general inventive concept. The leash assembly 1 includes a leash 2 and a shock absorbing leash extension 3 attached at an end of the leash 2. The leash assembly 1 is connected to a collar 9 of a pet 7. However, it should be understood that the leash assembly 1 can be used to tie the pet 7 to a post, tree, etc., and is not necessarily limited to walking the pet 7. The leash 2 may be any type of leash. The leash 2 includes a handle 8 for a user to hold when walking their pet 7. The leash 2 has a fastener 13 to connect to the leash extension 3. Since any type of conventional leash 2 can be used with the leash assembly 1, the user need not purchase an entire new leash, and instead can simply purchase the shock absorbing leash extension 3 and apply the leash extension 3 to the leash 2. In other words, the leash extension 3 is removably attachable to any leash 2.

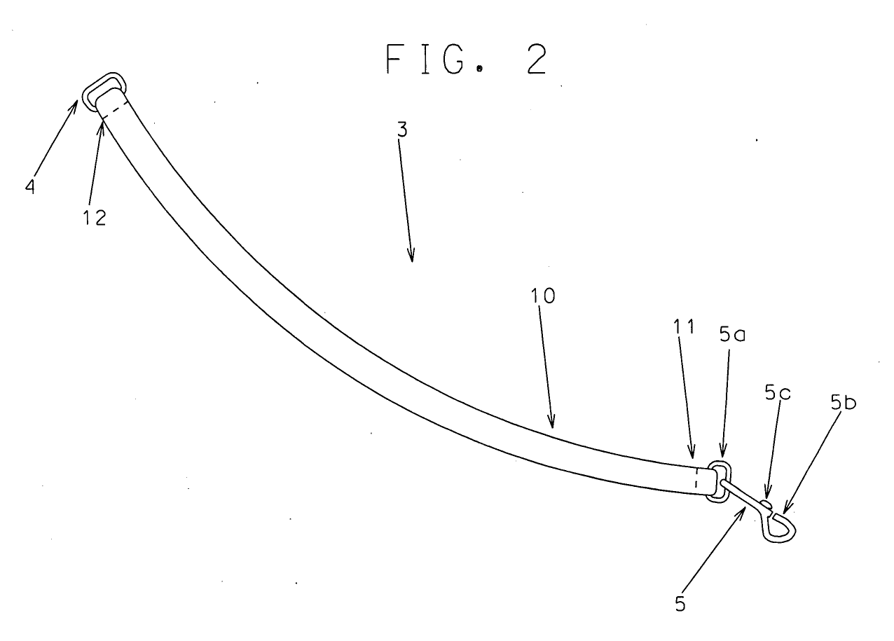

FIG. 2 illustrates the shock absorbing leash extension 3 according to an embodiment of the present general inventive concept.

The leash extension 3 includes an elastic portion 10 having a loop 4 at a first end thereof and a hook 5 at a second thereof. The loop 4 is connectable to the fastener 13 of the leash 2 (see FIG. 1). The hook 5 is connectable to the pet collar 9 (see FIG. 1). The loop 4 and the hook 5 may be first and second coupling portions to removably couple to leash extension 3 to the leash 2 and the pet collar 9.

Generally, pet collars have a collar loop through which leashes can be connected. The collar loop may also have a pet name tag attached thereto. The hook 5 of the leash extension 3 can be fastened to the pet collar 9 via a collar loop thereof.

The hook 5 may be similar to types of hooks that are used on ends of conventional leashes. Other types of couplers or fasteners may also be used with the present general inventive concept.

Referring to FIGS. 1 and 2, the elastic portion 10 may be a flat band made of an elastic material to provide a shock absorbing property to the leash extension 3. When the leash extension 3 is applied to the leash 2, the leash assembly 1 can have a variable maximum length such that a gradual pressure is applied to the pet 7 (e.g., to a neck of the pet 7). The maximum length can vary according to how much pressure the pet 7 applies to the leash assembly 1. Thus, the elastic portion 10 prevents an abrupt jerk to the pet's 7 neck when the pet 7 moves to the variable maximum length of the leash assembly 1. Additionally, when the pet 7 attempts to obtain more length (e.g., when the pet 7 wants to investigate something exciting) from the leash assembly 1, the pet 7 can obtain slightly more length from the elastic portion 10 of the leash extension 3.

The leash extension 3 may have a first stitched portion 12 at which the elastic portion 10 passes through the loop 4 and is stitched (or sewn) together to fix the leash extension 3 to the loop 4. Accordingly, the leash extension 3 can withstand large forces from strong/large pets. The leash extension 3 may have a second stitched portion 11 at which the elastic portion 10 passes through a looped portion 5a of the hook 5 and is stitched (or sewn) together to permanently fix the leash extension 3 to the hook 5. Although the present embodiment is described with respect to the stitched portions 12 and 11, the hook 5, and the loop 4, it should be understood that other types of fastening/coupling arrangements may alternatively be used with the leash extension 3. For example, the leash extension 3 may be a circular elastic band having the hook 5 and the loop 4 arranged thereon such that the first and second stitched portions 12 and 11 may not be necessary.

The hook 5 may include the looped portion 5a coupled to the elastic portion 10, a coupling portion 5b to couple to the collar 9, and a protrusion portion 5c to control the coupling portion 5b. For example, the protrusion portion 5c may control the coupling portion 5b to open and close such that the hook 5 can be connected to the collar 9. The coupling portion 5b may be movable with respect to the looped portion 5a. The coupling portion 5b may be curved and has a movable portion that opens and closes according to movement of the protrusion portion 5c.

The elastic portion 10 may be made of a variety of different elastic materials. For example, the elastic portion 10 may be made of an elastic band. The elastic portion may also be made of a rubber band or other stretchable material. The elastic portion 10 may be made of STRETCHRITE material manufactured by Medi-Dyne Healthcare products, Ltd. In some embodiments of the present general inventive concept, the elastic portion 10 may be made to provide more or less elasticity depending on a size of the pet 7 and/or the leash 2.

The leash extension 3 may be made various sizes. For example, the leash extension 3 may be less than one foot in length. Alternatively, the leash extension may be less than six inches in length.

The shock absorbing leash extension 3 may be used with a retractable leash 2 or a fixed length leash 2. For example, when the leash extension 3 is used with the retractable leash, the elastic portion 10 can minimize shocks on the neck of the pet 7 regardless of a current length of the retractable leash 2. Additionally, since the user of the retractable leash 2 typically makes the current length of the leash 2 shorter than a maximum length of the leash 2, the pet 7 may reach the maximum length of the leash 2 more frequently such that the shock absorbing leash extension 3 can absorbs shocks more frequently.

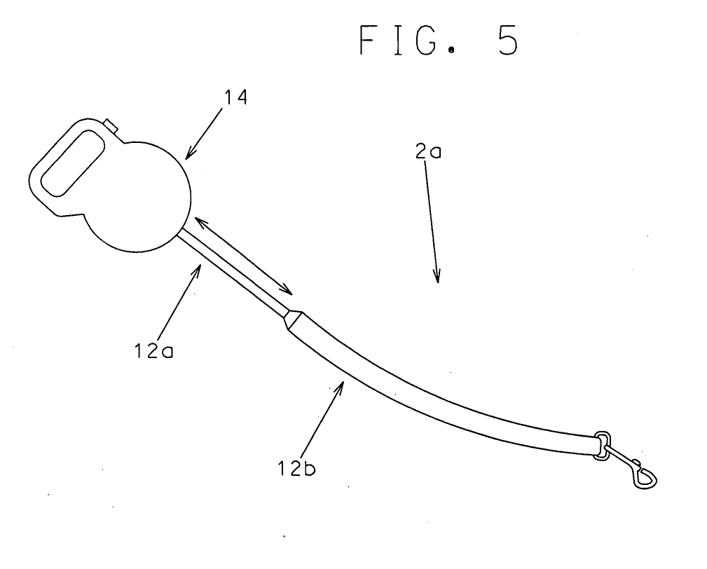

In some embodiments of the present general inventive concept, the leash extension 3 can be integrated with the leash 2 and/or the collar 9. For example, FIG. 5 illustrates a leash extension 12b integrated with a retractable leash 2a having a retractable portion 12a stored in a handle 14 and a non-retractable portion 12b as the leash extension 12b that extends from the handle 14. Accordingly, the shock absorbing leash extension 12b can be made as the non-retractable portion 12b of the retractable leash 2a such that the non-retractable portion 12b of the leash 2a has an elastic portion (not shown) and can minimize shocks and abrupt jerks.

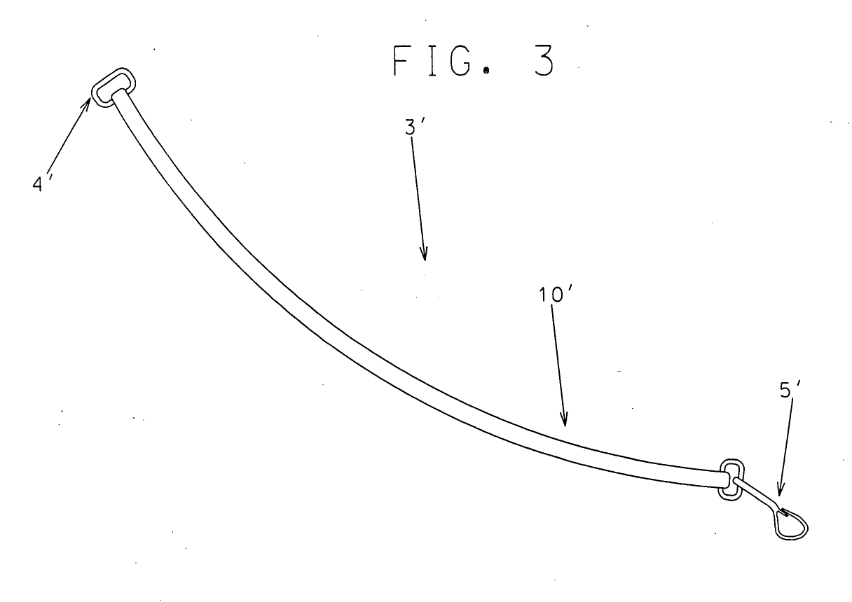

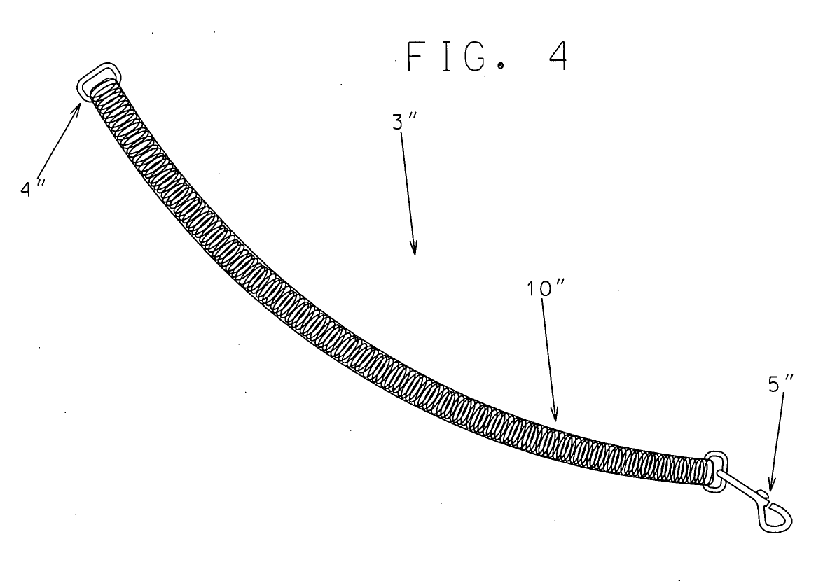

FIG. 3 Illustrates a shock absorbing leash extension 3′ according to another embodiment of the present general inventive concept, and FIG. 4 Illustrates a shock absorbing leash extension 3″ according to yet another embodiment of the present general inventive concept.

Referring to FIG. 3, the leash extension 3′ can operate similar to the leash extension 3 of FIG. 2. The leash extension 3′ includes a hook 4′, a flexible cord 10′, and a hook 5′. The flexible cord 10′ may be any type of stretchable/elastic/flexible cord, for example, bungee cord. Alternatively, the flexible cord 10′ can be an elastic cord or a flexible rubber cord. The flexible cord 10′ can be attached in a manner that is similar to the elastic portion 10 of FIG. 2. Alternatively, the flexible cord 10′ can be tied or permanently fixed to the hook 5′ and the loop 4′.

Referring to FIG. 4, the leash extension 3″ can operate similar to the leash extensions 3 and 3′ of FIGS. 2 and 3, respectively. The leash extension 3″ includes a spring portion 10″, a loop 4″, and a hook 5″. The spring portion 10″ may have a fabric covering (not shown) disposed thereon to cover the spring portion 10″. The fabric covering may be elastic to stretch with the spring portion 10″.

A shock absorbing leash extension of the various embodiments of the present general inventive concept is usable with any type of leash, thus a user does not need to purchase an entirely new leash or pet-walking apparatus. Additionally, the leash extension has a simple structure and absorbs shocks to a pet's neck, back, and spine that result when the pet gets to a maximum length of the leash. Accordingly, the pet does not suffer health problems from these abrupt jerks.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A shock absorbing leash extension, comprising:
an elastic portion having a first end and a second end;
a first loop disposed at the first end of the elastic portion and being connectable to a first hook on a leash; and
a second hook disposed at the second end of the elastic portion and being connectable to a second loop on a collar.

2. A leash assembly, comprising:
a leash having a handle portion disposed at a first end thereof and a first hook disposed at a second end thereof; and
a leash extension including an elastic portion having a first end and a second end, a first loop disposed at the first end of the elastic portion connected to the first hook on the leash, and a second hook disposed at the second end of the elastic portion.

3. The leash assembly according to claim 2, further comprising:
a collar having a second loop to be connected to the second hook of the leash extensions.

4. The leash assembly according to claim 2, wherein the leash comprises a retractable leash.

5. The leash assembly according to claim 2, wherein the elastic portion comprises:
a first stitched portion at the first end of the elastic portion forming a first looped portion in the elastic portion through which the first loop is disposed; and
a second stitched portion at the second end of the elastic portion forming a second looped portion in the elastic portion through which the second hook is disposed.

6. The leash assembly according to claim 2, wherein the second hook comprises:
a looped portion to couple to the second end of the elastic portion; and
a coupling portion to couple to a collar; and
a protrusion portion to control the coupling portion to open and close.

7. The leash assembly according to claim 2, wherein the elastic portion comprises one of an elastic band, an elastic cord, a bungee cord, a rubber band, a rubber cord, and a spring.

8. The leash assembly according to claim 7, wherein the elastic portion comprises a STRETCHRITE material.

9. The leash assembly according to claim 2, wherein the leash extension is less than one foot in length.

10. The leash assembly according to claim 9, wherein the leash extension is less than six inches in length.

11. A leash assembly, comprising:
a handle portion; and
a leash having a retractable portion removably wound inside the handle portion and an elastic non-retractable portion having a first end attached to the retractable portion and a second end with a hook connectable to a loop on a collar.
